(19) United States
(12) Patent Application Publication
(10) Pub. No.: US 2011/0120424 A1
(43) Pub. Date: May 26, 2011

(54) Method for Operating A Fuel Pump In A Motor Vehicle and Fuel Pump

(75) Inventors: Matthias Fischer, Datterode (DE); Stefan Gebühr, Gerstungen (DE); Reiner Grossmann, Wiegendorf (DE); Christoph Schmidt, Rotenburg (DE)

(73) Assignee: Continental Automotive GmbH, Hannover (DE)

(21) Appl. No.: 12/951,159

(22) Filed: Nov. 22, 2010

(30) Foreign Application Priority Data
Nov. 25, 2009 (DE) 10 2009 055 673.7
Jan. 14, 2010 (DE) 10 2010 004 658.2

(51) Int. Cl. F02M 37/04

(52) U.S. Cl. 123/497

(57) ABSTRACT

A method for operating a fuel pump in a motor vehicle and a fuel pump. A brushless direct current motor arranged in a housing of the fuel pump has a stator and a rotor on a shaft. When the rotor rotates at least one pump stage arranged in the housing is driven via the shaft. The variables of the direct current motor necessary for determining the commutation are fed to a processor in the engine controller of the motor vehicle. The processor generates the electrical signals for the commutation based on these variables according to the field-oriented closed-loop control. These electrical signals are fed to the brushless direct current motor for the commutation.

### BACKGROUND OF THE INVENTION

1. Field of the Invention

The subject matter of the invention is a method for operating a fuel pump in a motor vehicle, in which a brushless direct current motor, arranged in a housing of the fuel pump, has a stator and a rotor arranged on a shaft. When the rotor rotates, at least one pump stage, which is also arranged in the housing, is driven via the shaft.

2. Description of the Related Art

The brushless direct current motors of such fuel pumps are frequently embodied as electronically commutated brushless direct current motors and are used in fuel containers of motor vehicles to feed fuel from the fuel container to an internal combustion engine. The position of the rotor is a decisive variable for the determination of the commutation time. For the commutation, sensors are used that determine a position of the rotor in the direct current motor to determine the times for the commutation from this information. For this purpose, it is known to use Hall sensors, arranged offset around the shaft by 120°. The commutation can be implemented in various ways. A frequently used method for fuel pumps, which is defined by low costs, is 120° block commutation in which two phases are always energized. The acoustic behavior and the occurrence of torque ripple are considerable disadvantages of this commutation method.

Furthermore, there are further commutation methods. One of these methods is field-oriented commutation (field oriented control—FOC). According to this commutation method, all the phases are energized. This method of commutation is very flexible and powerful. The disadvantage of this method of commutation is that this method requires a considerable degree of computation which can only be overcome with correspondingly powerful processors. Such processors for fuel pumps are not available for reasons of cost.

### SUMMARY OF THE INVENTION

One embodiment of the invention is based on providing a method for operating a fuel pump that avoids the specified disadvantages and furthermore can be implemented as cost-effectively as possible. A second object is to provide a fuel pump which is of simple design and whose parameters are influenced as little as possible by the commutation.

According to one embodiment of the invention, the first object is achieved in that the variables of the direct current motor that are necessary for determining the commutation are passed on to a processor in the engine controller of the motor vehicle. The processor generates the electrical signals for the commutation based on these variables according to the field-oriented commutation, and in that these electrical signals are fed to the brushless direct current motor for the commutation.

The fact that the electrical signals which are necessary for the commutation are generated in a processor of the engine controller makes it possible to use the field-oriented commutation for brushless direct current motors in fuel pumps. The processors which are used are already so powerful that they can provide the computing power necessary for this type of commutation. This has the advantage that no additional processors for the commutation have to be arranged in the fuel pump. Using the field-oriented closed-loop control for a direct current motor of a fuel pump considerably increases the powerfulness of the fuel pump compared to 120° block commutation, since all the phases are energized in the case of field-oriented commutation. This makes it possible to use an electric motor of a relatively small size with the same electrical and mechanical parameters, as a result of which the fuel pump can also be smaller than previously used fuel pumps. Furthermore, the field-oriented closed-loop control permits sinusoidal energization, which has improved acoustic behavior compared to 120° block commutation by virtue of the reduced solid-borne sound. This is an important criterion of use in particular in fuel pumps.

In one embodiment, current values and voltage values of the motor coils are measured, fed to the processor and transformed mathematically into a rotor angle and angular speed in the processor. In this way, the position of the rotor is determined mathematically in the processor of the engine controller by electrical variables, and the electrical signals for the commutation of the brushless direct current motor are generated therefrom. There is therefore no need for sensors for determining the position of the rotor in the fuel pump. Omitting the sensors reduces the installation space which is required by a fuel pump which is embodied in such a way.

The second object is achieved according to one embodiment of the invention in that the fuel pump is connected to the engine controller of the motor vehicle. The engine controller has at least one processor for determining variables, which are necessary for the commutation of the brushless direct current motor, with the result that the variables which are necessary for the commutation, can be fed to this processor, and electrical signals generated by the processor according to the field-oriented closed-loop control can be fed to the direct current motor for the commutation.

Other objects and features of the present invention will become apparent from the following detailed description considered in conjunction with the accompanying drawing. It is to be understood, however, that the drawing is designed solely for purposes of illustration and not as a definition of the limits of the invention, for which reference should be made to the appended claims. It should be further understood that the drawing is not necessarily drawn to scale and that, unless otherwise indicated, it is merely intended to conceptually illustrate the structures and procedures described herein.

### BRIEF DESCRIPTION OF THE DRAWING

In the drawing:

FIG. 1 is a fuel pump arrangement in accordance with embodiment of the invention.

### DETAILED DESCRIPTION OF THE PRESENTLY PREFERRED EMBODIMENTS

The invention will be explained in more detail using an exemplary embodiment:

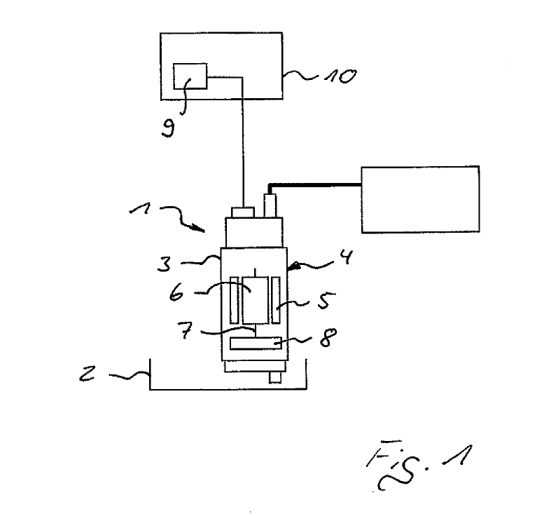

FIG. 1 illustrates a fuel pump 1 in a fuel container 2 of a motor vehicle. The fuel pump 1 has a housing 3 in which a direct current motor 4 is arranged. The direct current motor is composed of a stator 5 and a rotor 6. When the rotor 6 rotates, a pump stage 8 in the fuel pump 1 is driven via a shaft 7 of the rotor 6, as a result of which fuel is fed from the fuel container 2 to an internal combustion engine (not illustrated) of the motor vehicle. The fuel pump 1 is connected to a processor 9 of an engine controller 10 of the motor vehicle. Variables of the brushless direct current motor 4 which are necessary for the commutation are fed to the processor 9 via this connection. The electrical signals which are necessary for the commutation are then generated in the processor 9 according to the field-oriented closed-loop control and subsequently fed to the brushless direct current motor 4 for the commutation. If, as illustrated in this exemplary embodiment, no sensors are used for determining the position of the rotor, the position of the rotor in the processor 9 is determined by measuring current values and voltage values of the motor coils of the direct current motor 4, feeding said values to the processor 9 and transforming them mathematically into a rotor angle and angular speed in the processor 9, Subsequently, the electrical signals for the commutation can be generated from these values in the processor 9.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A method for operating a fuel pump in a motor vehicle, the fuel pump comprising:
a brushless direct current motor arranged in a housing of the fuel pump;
a stator; and
a rotor opposite the stator arranged on a shaft, wherein, when the rotor rotates at least one pump stage, which is also arranged in the housing and is driven via the shaft, the method comprising:
receiving variables of the brushless direct current motor that are necessary for determining commutation by a processor in an engine controller of the motor vehicle;
generated by the processor electrical signals for the commutation based at least in part on variables according to field-oriented closed-loop control; and
providing the electrical signals to the direct current motor for the commutation.

2. The method as claimed in claim 1, further comprising:
measuring current values and voltage values of motor coils;
receiving by the processor the measured current and voltage values; and
transforming the measured current and voltage values mathematically into a rotor angle and angular speed to determine the position of the rotor of

3. A fuel pump in a motor vehicle, comprising:
a housing;
a brushless direct current motor arranged in the housing comprising a stator and a rotor arranged on a shaft, when the rotor rotates, at least one pump stage, which is also arranged in the housing, is driven via the shaft;
an engine controller of the motor vehicle coupled to brushless direct current motor, the engine controller comprising at least one processor configured to determine variables necessary for commutation of the brushless direct current motor, the variables necessary for the commutation are received by this processor, and electrical signals which are generated by the processor according to a field-oriented closed-loop control are provided to the direct current motor for the commutation.
